(19) United States
(12) Patent Application Publication
(10) Pub. No.: US 2023/0405372 A1
(43) Pub. Date: Dec. 21, 2023

(54) Mouth-Nose Mask

(71) Applicant: STG MEDICAL AG, Winterthur (CH)

(72) Inventor: Michael Schwager, Winterthur (CH)

(73) Assignee: STG MEDICAL AG, Winterthur (CH)

(21) Appl. No.: 18/037,583

(22) PCT Filed: Aug. 24, 2021
(86) PCT No.: PCT/EP2021/073395

§ 371 Date: May 18, 2023

(30) Foreign Application Priority Data
Nov. 19, 2020 (WO) PCT/EP2020/082745
Mar. 25, 2021 (WO) PCT/EP2021/057826

(51) Int. Cl. A62B 23/02; A62B 18/08; A41D 13/11; B01D 46/00; B01D 39/14

(52) U.S. Cl. CPC A62B 23/025; A62B 18/08; A62B 18/084; A41D 13/1161; A41D 13/113; B01D 46/0001; B01D 39/14; A41D 2400/00; A41D 2200/00; B01D 2239/10; B01D 2239/0677; B01D 2275/10

(57) ABSTRACT

A mouth-nose mask for reducing the transmission of pathogens via droplets of secretion is disclosed. The mouth-nose mask includes a central fold which defines a chin-nose line of the mouth-nose mask and separates the mouth-nose mask into two substantially congruent halves. A fastening means for fastening the mouth-nose mask to a wearer's ears or back of the head is attached to the ends of the two halves remote from the central fold. The mouth-nose mask includes at least two superposed layers of a filter material, the at least two layers defining the outer shape of the mouth-nose mask and being only partially joined to one another at their edges.

### CROSS REFERENCE TO RELATED APPLICATIONS

This application is a national phase application of International Application No.: PCT/EP 2021/073395, filed on Aug. 24, 2021, which claims priority from two other International Patent Application Nos.: PCT/EP 2020/082745 filed 19 Nov. 2020 and PCT/EP2021/057826 filed 25 Mar. 2021, the content of all of the aforementioned application being herein incorporated by reference.

### BACKGROUND OF THE INVENTION

### Field of the Invention

The invention relates to a mouth-nose protection, in particular for reducing the transmission of pathogens by secretion droplets, and to a method for producing a mouth-nose protection. Further, the invention relates to the use of a mouth-nose protection for reducing the transmission of pathogens by secretion droplets.

### Description of Related Art

Mouth-nose protection is the term used to describe air-permeable half-face masks that cover both the mouth and nose areas when used as intended. Mouth-nose protection is sometimes also referred to as mouth-nose mask, surgical mask, medical face mask, clinic mask, surgical face mask or hygiene mask.

Mouth-nose protection is used to reduce the transmission of pathogens, such as viruses or bacteria, through secretion droplets, which is particularly important in connection with the so-called coronavirus pandemic, but also in the case of other known viral diseases that can be transmitted through secretion droplets, in order to prevent the further spread of the virus. For this purpose, the mouth-nose protection typically has a filter medium embedded between two layers of nonwoven fabric, which absorbs the secretion droplets that are emitted from the mouth and nose, e.g. when speaking, coughing or sneezing.

In order for the mouth-nose protection to develop its optimum effect, it must seal the mouth and nose area as tightly as possible so that most of the breathing air flows through the filter material as it enters and exits. For this purpose, the mouth-nose protection is usually pulled onto the back of the head or behind the ears of the wearer with bands or elastic straps and fixed in place. To improve the seal in the nose area and to keep the wearer's field of vision free, many mouth-nose protectors have integrated metal brackets at the upper edge, which allow the mouth-nose protection to be better adapted to the shape of the wearer's face in this area. The better the mouth-nose protection fits the wearer's face, the lower the proportion of breathing air that flows past the mouth-nose protection when breathing.

However, the disadvantage of known mouth-nose protections is that they often adapt poorly to the shape of the face, form bulges and slip when worn, resulting in leaks between the face and mouth-nose protection. In addition, well-known mouth-nose protectors are usually moderately comfortable to wear. There are also so-called fabric masks, which are usually more comfortable to wear. However, producing them is relatively costly and the protective effect is usually less than that of conventional disposable hygiene masks.

There is therefore still a need for improved mouth-nose protection that does not comprise the above-mentioned disadvantages, or comprises them to a lesser extent.

### BRIEF SUMMARY OF THE INVENTION

The object of the invention is therefore to provide an improved mouth-nose protection. In particular, the mouth-nose protection should be designed in such a way that it adapts as well as possible to the shape of the face, is comfortable to wear and offers as good a protective effect as possible. In addition, it is desirable for the mouth-nose protection to be as easy as possible to manufacture and to comprise as long a service life as possible.

The solution to these objects is defined by the features of independent claim 1 and the further independent claims.

A first aspect of the present invention thus relates to a mouth-nose protection, in particular for reducing the transmission of pathogens by secretion droplets, wherein the mouth-nose protection comprises a central fold which defines a chin-nose line of the mouth-nose protection and divides the mouth-nose protection into two substantially congruent halves, and a means for fastening the mouth-nose protection to the ears and/or to the back of the head of a wearer is attached to each of the ends of the two halves remote from the central fold wherein the mouth-nose protection comprises at least two superimposed layers of a filter material defining the outer shape of the mouth-nose protection, the at least two layers being only partially connected at their edges.

The combination of a central fold and at least two superimposed layers of filter material, which are only partially joined at the edges and define the outer shape of the mouth-nose protection, makes it possible to produce mouth-nose protection in a simple manner which, on the one hand, sits in a defined position on the face, at the same time adapts as well as possible to the shape of the face and, on the other hand, is very comfortable to wear. In addition, a very high filtering effect or low permeability for pathogens such as bacteria or viruses can be achieved with relatively low breathing resistance.

Without being bound by theory, it is believed that the only partial connection at the edges allows the at least two layers of filter material to move against each other more easily when deformed. This allows the layers to better conform to facial shapes, resulting in a better seal between the mouth-nose protection and the face on the one hand, and is perceived as more comfortable for the wearer on the other. Overall, the mouth-nose protection feels softer and more flexible than a comparable mouth-nose protection in which the at least two layers are substantially continuously connected at the edges.

Furthermore, it has been shown that the mouth-nose protection according to the invention can be reused several times and can also be washed. Further advantages of the mouth-nose protection according to the invention result from the following explanations.

The indications “top”, “bottom”, “front” and “back” refer in the present case to the mouth-nose protection when it is worn on the face as intended. “Front” refers to the area of the mouth-nose protection that lies in front of the wearer's nose and/or mouth, while “back” refers to the area of the mouth-nose protection that faces the back of the wearer's head. Accordingly, “bottom” refers to the areas of the mask facing the neck and “top” refers to the areas of the mask facing the upper half of the head.

The “rim” refers to the outer boundary of the mouth-nose protection. This includes in particular the central fold.

A “fold” is in particular a structural wrap line.

The at least two superimposed layers of the filter material define the outer shape of the mouth-nose protection. The at least two superimposed layers of the filter material are thereby preferably substantially congruent and they further preferably lie congruently on top of each other.

The layers of the filter material are thus not, as in certain known mouth-nose protectors, merely inserted as a simple filter part in an outer envelope which forms the outer shape. The design according to the invention achieves a uniform filter effect over the entire mouth-nose protection and a better adaptation to the shape of the face.

According to an advantageous embodiment, the mouth-nose protection comprises no further layers apart from the at least two superimposed layers of filter material. In particular, no layers which correspond to the outer shape of the mouth-nose protection.

The term “partial connection” refers in particular to a connection in sections in which, in addition to connected sections, there are also sections without connection. Particularly preferably, the at least two layers are connected to each other over less than 50%, in particular 2-40%, in particular 5-35%, of the total length of their edges.

In particular, the partial connection is a materially bonding connection, especially a welded connection. This means that the connection is permanent or no longer releasable. A materially bonded connection can be achieved, for example, by adhesively bonding. However, welded connections are particularly preferred, since in this case no additional connecting means are required.

Particularly preferably, at the upper edges of the two halves, which run from the uppermost region of the central fold to the free ends of the two halves, the at least two layers of the filter material, between the free ends and the uppermost region of the central fold, are not bonded to one another.

Preferably, at the lower edges of the two halves, which extend from the lowermost region of the central fold to the free ends of the two halves, the at least two layers of filter material, between the free ends and the lowermost region of the central fold, are not bonded together.

These areas of the mouth-nose protection are strongly deformed when put on the face, so that a certain relative movement between the at least two layers strongly improves the forming, which increases the tightness of the mouth-nose protection as well as the wearing comfort.

Particularly preferably, the upper edges of the two halves, which run from the uppermost region of the central fold to the free ends of the two halves, comprise a concave downward curved shape. This allows the mouth-nose protection to better conform to the transition between the nose and cheek area without causing an undesirable bulge. In principle, however, other shapes are also conceivable.

The lower edges of the two halves, which run from the lowermost region of the central fold to the free ends of the two halves, are preferably straight. This allows the mouth-nose protection to be optimally pulled backwards and at the same time the lower parts of the face are covered by the mouth-nose protection. However, differently shaped edges, e.g. concave upwardly curved edges, are also possible.

According to a further advantageous embodiment, the mouth-nose protection is symmetrical with respect to an axis of symmetry which runs from the central region of the front end, in particular from the central region of the central fold, to the central region of the rear end of the mouth-nose protection. This in particular when the two halves lie on top of each other. A symmetrical shape of the mouth-nose protection has the advantage that it is always correctly tightened regardless of the orientation, which increases safety.

It has been found particularly preferable that the upper edges of the two halves, which run from the uppermost region of the central fold to the free ends of the two halves, comprise a concave downward curved shape, while the lower edges of the two halves, which run from the lowermost region of the central fold to the free ends of the two halves, comprise a corresponding concave upward curved shape.

The at least two layers of the filter material are preferably at least partially, in particular completely, joined together in the region of the central fold. This is preferably a materially bonding, in particular a welded joint. In the area of the central fold, a relative movement of the at least two layers is not necessary to achieve a good adaptation to the shape of the face. However, the partial joint creates a stable connection between the two layers and a defined chin-nose line.

According to a particularly preferred embodiment, the at least two layers of the filter material are bonded together exclusively in the region of the central fold and in the regions of the free ends of the two halves. This gives particular prominence to the advantages of the invention and at the same time provides a robust mouth-nose protection.

It is further preferred if the at least two layers of the filter material are not connected to each other in the regions within the edge regions and/or if the two layers of the filter material are connected exclusively partially in the edge regions. This achieves a particularly advantageous relative mobility between the layers.

For special embodiments, however, one or more connections, e.g. punctual and/or linear connections, may also be provided within the edge regions. Under certain circumstances, this can benefit the dimensional stability of the mask.

Preferably, the at least two layers of the filter material lie loosely and/or unconnected on top of each other over at least 50%, in particular at least 75%, preferably at least 90%, of their area.

The central fold preferably comprises at least two sections.

According to an advantageous embodiment, the central fold comprises a lower section and an upper section, the upper section running at an angle to the lower section. An angle between the two sections is preferably 10-80°, in particular 15-50°. In particular, the first and/or the second section run in a straight line.

With such a central fold, the upper section can encompass the area of the tip of the wearer's nose, while the lower section covers the mouth and chin area of the wearer, this in particular without encompassing the chin. This can make it easier to move the jaw under the mouth-nose protection, e.g. when speaking.

According to a further advantageous embodiment, the central fold preferably comprises a lower section, a middle section and an upper section, wherein the lower section and the upper section extend at an angle to the middle section. In particular, this is done in such a way that the lower and upper sections of the central fold are directed obliquely backwards.

The lower and/or the upper section thereby preferably comprise an angle of 10-80°, in particular 15-50°, to the middle section.

It is further preferred if all sections of the central fold are straight.

With such a central fold, the upper section can embrace the area of the tip of the wearer's nose, while the lower section can embrace the chin area of the wearer. The middle section then lies in front of the mouth area. This automatically centers the mouth-nose protection in a defined position on the face. In particular, this prevents the mouth-nose protection from slipping during speech or facial movements. According to a preferred embodiment, the at least two layers consist of the same filter material. This greatly simplifies production.

However, it is also possible that the at least two layers consist of different filter material. In this way, for example, the filter effect can be adjusted or the wearing comfort of the mouth-nose protection can be adapted.

Particularly preferred is the filter material a suspended matter filter material, especially for the separation of bacteria and viruses, preferably with a diameter <1 μm, especially <0.6 μm.

More particularly, the filter material is a nonwoven fabric. For example, the filter material is an EPA or HEPA filter material, such as those used in vacuum cleaners.

Particularly preferably, the least two layers of the filter material together comprise a permeability for particles up to a size of 0.6 μm, measured according to EN 149:2001+A1:2009, of at most 6%, preferably of at most 1%, in particular at most 0.5%. This achieves a high protective effect with regard to droplet infections.

Preferably, the filter material contains synthetic fibers, in particular polyolefin and/or polyester fibers, or consists thereof. Filter materials containing synthetic fibers have the advantage that they can be easily welded, so that the at least two layers of the filter material can be joined without additional joining means.

However, filter materials made of other fibers can also be used.

The above-mentioned filter materials are known to the skilled person per se and they can be purchased commercially from various suppliers.

According to a further advantageous embodiment, an additional fold is introduced in each of the two halves, in particular in such a way that when the two halves lie one on top of the other, the regions of the halves lying behind the additional folds can be folded in a superimposed arrangement onto the regions lying in front of the additional folds.

This allows the mouth-nose protection to be folded compactly when not in use so that it can be stowed more easily in a trouser pocket, for example.

Preferably, the additional folds extend substantially parallel to the central fold and/or the central portion of the central fold. This allows the mouth-nose protection to be folded without having to additionally fold the central fold.

Moreover, the mouth-nose protections according to the invention do not require additional shaping elements, such as metallic nose clips. According to a preferred embodiment, the mouth-nose protection according to the invention therefore does not contain any additional shaping elements, in particular no additional shaping elements in the area of the nose section, very preferably no metallic nose clips.

Preferably, the mouth-nose protection has a magnetic retaining element that allows the mask to be attached to a third party element, such as a metallic portion of a clothing item, when not in use.

In particular, the magnetic retaining element is attached to the means for attaching the mouth-nose protection to the ears or back of the head of a wearer.

It is further preferred if a tactile marking, preferably a projection, is attached to the mouth-nose protection in the region of the central fold, in particular at its upper or lower end. This allows the orientation of the mouth-nose protection to be easily identified by touch, even in complete darkness.

It is further preferred if a structuring is present in an uppermost section of the central fold at the free edge. The structuring preferably includes one or more projections projecting forward and/or upward, in particular sawtooth-shaped projections. On the one hand, the structuring serves to make the nose area of the mouth-nose protection palpable and/or to prevent the wearer's glasses from slipping if necessary. In particular, the structuring can prevent the glasses from slipping over the mouth-nose protection along the edge of the nose. According to another preferred embodiment, a luminescent marking, preferably a fluorescent and/or phosphorescent marking, is provided in the region of the central fold, in particular at its upper and/or lower end. This allows the orientation of the mouth-nose protection to be visually identified in the dark.

According to a particularly preferred embodiment, the structuring comprises a plurality of upwardly projecting rectangular projections, in particular rounded rectangular projections. In other words, the rectangular projections preferably comprise a convexly shaped upper edge. This makes the individual projections more pleasant to feel and reduces the risk of people injuring themselves on pointed projections.

The rectangular projections are preferably spaced apart, in particular regularly spaced apart. This makes it possible, for example, to prevent spectacles from slipping in various positions.

However, the markings are optional and can also be omitted.

In particular, a coating is applied to the inside of the innermost filter layer in the upper area to increase friction on human skin. Such a coating may also be referred to as an anti-slip coating. More particularly, the coating is a synthetic coating, in particular a rubber coating, preferably a latex coating.

In particular, the coating for increasing friction on human skin is applied such that, when the mouth-nose protection is used as intended, it comes to rest on the bridge of the nose, in particular the lower portion of the bridge of the nose. In particular, the coating may be applied in the area of the upper portion of the central fold.

The coating to increase friction on human skin can additionally counteract slipping of the mouth-nose protection, e.g. during facial movements.

However, such a coating is optional and may be omitted.

In a further embodiment, at least one projection and/or at least one recess is present in a partial section of each of the upper edges of the two halves, which extend from the uppermost region of the central fold to the free ends of the two halves. Preferably, the projections are attached to the innermost layer of the filter material and, in particular, are folded inwardly so as to rest on the inner sides of each of the two halves. Preferably, the projections are spaced from the central fold and are arranged in particular in such a way that they come to lie in the region of the transition from the nose to the cheek area during intended use.

The projections are preferably integral components of the filter material. However, it is also possible to attach the projections as separate components to the two halves, e.g. by materially bonding, in particular by adhesively bonding and/or welding.

The at least one projection on each of the two halves acts as a sealing lip, which reduces the unwanted intake and/or outflow of breathable air at the transition of the nose to the cheek areas of the wearer. A recess can improve the fit of the mouth-nose protection in the nose-cheek region, which also increases tightness.

In particular, there are several projections, which are preferably directly adjacent to each other, or there is one projection on each of the two halves, which is divided into several separate sections in the area of its free end. This further improves the tightness at the transition of the nose to the cheek areas of the carrier. This is probably due to the fact that several projections or a projection with subdivided sections at the free end can be better formed to the transition from the nose to the cheek area.

According to a preferred embodiment, the projection is a convex curved projection and/or the recess is a concave curved recess. Convex shapes of the projections have been found to be particularly advantageous.

In another advantageous embodiment, the projection is a rectangular projection. In this case, there are preferably several rectangular projections on each of the two halves, which are preferably directly adjacent to one another, or there is one rectangular projection on each of the two halves, which is divided into several separate sections in the region of its free end. This has also proved to be a particularly preferred measure for increasing the tightness at the transition of the nose to the cheek regions of the beam.

In another advantageous embodiment, a cushioning element is attached to each of the upper edges of the two halves on the inside of the mouth-nose protection. The cushioning elements are preferably spaced on both sides of the central fold and, in particular, are arranged in such a way that they come to lie in the region of the transition from the nose to the cheek area during intended use. In the region of the central fold, there is preferably no cushioning element at the upper edge. In other words, the two post elements are spaced apart from each other and/or not connected to each other at the two halves.

On the one hand, the cushioning elements can increase the wearing comfort and, on the other hand, an additional seal is achieved at the transition of the nose to the cheek area.

Preferably, the cushioning elements have a lower material thickness at an end facing the central fold and/or an end facing away from the central fold than in a central area in between. Preferably, the material thickness increases continuously from both sides towards the central region. The continuous increase can be linear and/or corresponding to a curved line, for example. In this way, continuous flexibility transitions are obtained in one direction along the upper edges, which increases wearing comfort and improves the seal.

Preferably, the front ends of the cushioning elements are tapered in a wedge shape and/or the front end faces are slanted backwards. This creates a more continuous transition in the nose area. Similarly, it is preferred if the rear ends of the cushioning elements are tapered in a wedge shape and/or the rear end faces are at an angle to the rear. This results in a more continuous transition to the cheek area.

The cushioning elements are preferably in the form of a wedge cuboid or an elongated parallelepiped.

According to a further advantageous embodiment, the cushioning elements have the shape of a trapezoidal prism. In particular, the trapezoidal bases of the cushioning elements are attached to the upper edges of the two halves on the inside of the mouth-nose protection. This in particular so that the longest side of the trapezoidal base surface runs along the respective upper edge.

The trapezoidal prismatic cushioning elements result in particularly continuous flexibility transitions in one direction along the upper edges, which in turn contributes to a better seal in the nose and cheek area. Insofar as an additional fold is introduced in each of the two halves, as described above, the cushioning elements on the two halves are preferably arranged in front of the additional folds in each case. This makes it easier to fold the two halves around the folds. In particular, in this case, the cushioning elements do not have to be folded along when the areas of the halves located behind the additional folds are folded in a superimposed arrangement onto the areas located in front of the additional folds. This allows the mouth-nose protection to be folded more compactly when not in use.

According to a further advantageous embodiment, the two substantially congruent halves are connected to each other in an area spaced from the edges and the central fold via a connecting element. The connecting element is preferably a thread-like element, particularly preferably an elastic band and/or a thread. In particular, it is a thread.

Preferably, the connecting element is arranged in such a way that it extends between the upper lip and the lower edge of the nose of the wearer when the mouth-nose protection is used as intended. In particular, the connecting element is arranged 0.5-2.5 cm, especially 1-2 cm, behind the central fold. In particular, the connecting element is spaced from the upper end of the central fold by a distance of 15-50%, in particular 20-40%, of the total length of the central fold.

A length of the connecting element preferably corresponds somewhat to the intended width of a nose, in particular approx. 1-4 cm, in particular 2-3 cm. Therefore, for different sizes of the mouth-nose protection, the length of the connecting element may be different.

Preferably, the means for fastening the mouth-nose protection to the ears or to the back of the head of a wearer comprises an elastic band, a ribbon and/or one or more loops made of an elastic material.

Particularly preferably, the means for attaching the mouth-nose protection to the ears or the back of the head of a wearer comprises a loop of an elastic material at each of the two ends facing away from the central fold.

The means for fastening the mouth-nose protection to the ears or to the back of the head of a wearer is preferably attached to the mouth-nose protection in a materially bonded manner, particularly preferably by welding.

Preferably, at least one, preferably two, stoppers are attached to the means for attaching the mouth-nose protection to the ears or to the back of the head of a wearer, with which the length of the means for attaching the mouth-nose protection to the ears or to the back of the head of a wearer can be adjusted. This may, for example, be a clamping stopper, in which the means or means for fastening the mouth-nose protection to the ears or to the back of the head of a wearer can be clamped in an opening by a spring mechanism.

It is further preferred if one or more markings, in particular in the form of a scale, are present on the means for fastening the mouth-nose protection to the ears or to the back of the head of a wearer. This in particular in such a way that a stopper can be moved and positioned along the marking(s). The mark or markings are preferably one or more colored markings, particularly in the form of a colored scale. With such markings, the wearer can easily and reproducibly set the appropriate width on the means for fastening the mouth-nose protection to the ears or the back of the head of a wearer.

Preferably, on a left side of the means for fastening the mouth-nose protection to the ears or to the back of the head of the wearer, there is or are one or more markings, in particular in the form of a scale, which comprise a different coloring than one or more markings, in particular in the form of a scale, which are applied to the right side of the means for fastening the mouth-nose protection to the ears or to the back of the head of the wearer. This makes it easy to visually distinguish between the left and right sides of the mouth-nose protection, which helps in the correct donning of the mouth-nose protection.

In particular, as a means of fastening the mouth-nose protection to the ears or the back of the head of a wearer, a loop made of an elastic material is attached to each of the two ends facing away from the central fold, each of the loops having one or more markings, in particular in the form of a scale.

Preferably, the marking(s) applied to the two loops, in particular in the form of a scale, comprise(s) a different coloring. Due to the different coloring, the user can detect the left and the right side of the mouth-nose protection in a simple and reliable manner. This allows the mouth-nose protection to be put on the right way up right away.

Specifically, the two loops each have a color marking at the rearmost end, and the color marking on the left loop is different from the color marking on the right loop. This allows the left and right sides of the mouth-nose protection to be distinguished, even when viewed from the rear in a folded state.

According to a further preferred embodiment, the mouth-nose protection has at least one fixing element with which the two congruent halves can be held together at the ends facing away from the central fold when not in use. This allows the mouth-nose protection to be folded in a well-defined state and stowed, for example, in a trouser or jacket pocket without the mouth-nose protection becoming crumpled or soiled on the inside.

Preferably, the fixing element includes at least two magnets, one magnet each being attached to the ends of the two congruent halves of the mouth-nose protection facing away from the central fold. In particular, the magnets are arranged in such a way that they are attracted to each other by a magnetic force when they are placed one on top of the other.

Particularly preferably, at least two spaced-apart magnets are attached to each of the two halves, which can interact with the two magnets opposite each other. This allows the two halves to be held even more stably in the folded state.

However, other fixing elements, e.g. clips, press studs, hooks and/or eyelets, are also possible.

It is further advantageous if there is a protruding gripping element at the central fold for gripping the mouth-nose protection with two fingers. The gripping element makes it possible to reposition the mouth-nose protection if it should slip during wearing. In particular, the gripping element is designed in such a way that, when the mouth-nose protection is worn as intended, it projects away from the wearer's face in one direction.

Due to the arrangement at the fold, the mouth-nose protection can be moved in all directions by the gripping element in a simple manner and in a targeted manner. Furthermore, the gripping element simplifies the removal of the mouth-nose protection.

The aforementioned advantages are particularly effective if the central fold is formed by a materially bonded connection, in particular by a welded connection of the at least two layers of the filter material. As a result, the central fold typically has an increased stability, which leads to the fact that the movements at the gripping element are transmitted along the entire length of the central fold, which simplifies the correct positioning of the mouth-nose protection.

According to a particularly advantageous embodiment, the mouth-nose protection therefore has a gripping element which is present at the central fold and protrudes for gripping the mask with two fingers, and the at least two layers of the filter material are at least partially, in particular completely, materially bonded to one another in the region of the central fold, in particular welded.

A free end of the gripping element facing away from the central fold is preferably thicker, at least in sections, than a region facing the central fold. This allows the gripping element to be gripped more securely and reduces the risk of slipping.

It is further preferred if the free end of the gripping element facing away from the central fold is designed as a curved edge. This avoids sharp corners, which reduces the risk of injury. It also improves the aesthetics.

A length of the gripping element, measured in a direction along the central fold, in the longest region is, for example, 5-50 mm, preferably 8-25 mm. A thickness of the gripping element, measured in a direction transverse to the central fold, in the thickest region is for example 0.1-5 mm, preferably 0.3-2 mm. Such dimensions have proved to be particularly advantageous. Corresponding gripping elements can be gripped well, but nevertheless do not add excessive weight.

It has proved particularly advantageous if the gripping element is arranged in a central region of the central fold, in particular approximately centrally in a direction of the central fold. At this point, the gripping element is easily accessible and enables simple positioning of the mouth-nose protection on the face.

Particularly preferably, the gripping element is thereby arranged in the aforementioned central section of the central fold, preferably in a central region of the central section. Accordingly, in this embodiment, the central fold comprises a lower section, a middle section and an upper section, wherein the lower section and the upper section extend at an angle to the middle section.

Preferably, the gripping element is formed substantially of filter material, the gripping element being particularly preferably integrally formed with the at least two superimposed layers of the filter material. In particular, the gripping element is produced by at least area-wise materially bonded joining of the filter material, in particular welding of the filter material.

This simplifies producing, since no additional elements need to be attached. However, it is also possible to attach the gripping element in the form of an additional element.

It is further advantageous if the region of the gripping element facing the central fold consists of a materially bonded connection of filter material, while in the region of the gripping element facing away from the central fold the filter material is not materially bonded. The materially bonded connection is in particular a welded connection. Thus, a gripping element as described above with a thickened free end can be produced in a simple manner. Specifically, during welding, for example, the filter material can be compressed in the region facing the central fold, while the filter material in the non-welded region of the free end retains its original thickness.

For transport, storage and keeping purposes, the mouth-nose protection is in particular sealed in a plastic foil, in particular by vacuum welding.

The mouth-nose protection is present in particular folded around the additional folds, with the means for fastening the mouth-nose protection to the ears or the back of the head of a wearer being present next to the folded layers.

As a result, the mouth-nose protection remains protected from environmental influences and mechanical damage in the best possible manner until it is used for the first time.

Another aspect of the present invention relates to a method for producing a mouth-nose protection as described above, wherein at least two superimposed layers of a filter material defining the outer shape of the mouth-nose protection are only partially joined at their edges.

As mentioned above, the connection is preferably made by a materially bonded connection technique, in particular by welding.

A first particularly preferred method comprises the following steps:
a) providing a one-piece first layer of filter material having an axisymmetric shape and a substantially congruent one-piece second layer of filter material, and arranging the two layers one above the other;
b) Folding of the two layers along the axis of symmetry and creation of a central fold;
c) Partial joining of the two layers at their edges;
d) attaching one means of securing the mouth-nose protection to the ears or to the back of the head of a wearer at each end of the two halves away from the central fold.

In this method, the mouth-nose protection can be produced from one-piece layers.

A second particularly preferred method comprises the following steps:
a) providing a first half of a first layer of a filter material and a second half of the first layer;
b) providing a first half of a second layer of a filter material and a second half of the second layer, wherein the halves of the second layer are substantially congruent with the halves of the first layer;
c) superimposing the first half of the first layer and the first half of the second layer and the second half of the first layer and the second half of the second layer;
d) Partial joining of the layers in the edge area of the intended chin-nose line of the mouth-nose protection with formation of a central fold;
e) attaching a means of securing the mouth-nose protection to the ears or to the back of the head of a wearer at each end of the two halves facing away from the central fold.

In this method, the individual halves are joined at the central fold.

Another aspect of the present invention relates to the use of a mouth-nose protection as described above for reducing the transmission of pathogens by secretion droplets.

From the following detailed description and the totality of the claims, further advantageous embodiments and combinations of features of the invention are apparent.

### BRIEF DESCRIPTION OF THE SEVERAL VIEWS OF THE DRAWINGS

Further advantages, features, and details of the various embodiments of this disclosure will become apparent from the ensuring description of a preferred exemplary embodiment and with the aid of the drawings. The features and combinations of features recited below in the description, as well as the features and feature combination shown after that in the drawing description or in the drawings alone, may be used not only in the particular combination received, but also in other combinations on their own, without departing from the scope of the disclosure.

The drawings used to explain the embodiment show:

FIG. 1a first mouth-nose protection according to the invention in a top view from the left side;

FIG. 2 the mouth-nose protection of FIG. 1 viewed from above;

FIG. 3 the mouth-nose protection shown in FIGS. 1 and 2 in the wearing position on the head of a wearer (the mouth-nose protection is shown transparent for better illustration);

FIG. 4a second mouth-nose protection according to the invention with an only partially welded central fold in a top view on the left side;

FIG. 5a third mouth-nose protection according to the invention, which in a partial section of the upper edge has a convexly curved projection as a sealing lip;

FIG. 6a fourth mouth-nose protection according to the invention, which has an additional concave curved recess in a partial section of the upper rim;

FIG. 7 on the left side, the individual layers of filter material which are provided for producing the mouth-nose protection from FIGS. 1-3 and are welded at the left edge areas to form a central fold. On the right side of FIG. 7 the further components are shown;

FIG. 8a layer of filter material consisting of two congruent halves, as used for producing the mouth-nose protection of FIG. 4;

FIG. 9 the mouth-nose protection from FIGS. 1-3 in folded condition;

FIG. 10 the mouth-nose protection from FIGS. 1-3 in folded condition in a plastic foil in vacuum-sealed condition;

FIG. 11 a top view from the left side of another mouth-nose protection, which is constructed like the mouth-nose protection from FIGS. 1-3, but in contrast to the latter has a two-part central fold;

FIG. 12 a top view from the left side of a mouth-nose protection, which has a structuring at the upper section of the central fold in the form of several sawtooth-shaped projections projecting upwards to the front;

FIG. 13 a top view of a mouth-nose protection with a connecting element in the form of a fabric thread connecting the two substantially congruent halves;

FIG. 14 the mouth-nose protection of FIG. 13 in the wearing position on the head of a wearer (the mouth-nose protection is shown transparent for better illustration) with the connecting element running between the nose and the upper lip;

FIG. 15 another mouth-nose protection in a top view from the left side, the mouth-nose protection being essentially identical in construction to the mouth-nose protection of FIG. 5, but instead of the convexly curved projection it has four rectangular projections which lie adjacent to one another and are folded onto the inner side;

FIG. 16 the inner layer of filter material used for producing the left half of the mouth-nose protection of FIG. 15 in a top view;

FIG. 17 a variant of the mouth-nose protection FIG. 4 in a top view from the left;

FIG. 18 a mouth-nose protection with additional cushioning elements viewed from the top side;

FIG. 19 a mouth-nose protection in a top view from the left side, which is symmetrical with respect to its longitudinal axis;

FIG. 20 a side view of another mouth-nose protection which has structuring in the form of several upwardly projecting rounded rectangular projections in an upper section of the central fold, as well as scales and color markings on the fastening loops;

FIG. 21 the mouth-nose protection shown in FIG. 20, viewed from above. The scale on the left side of the fastening loop and the color marking at the end of the loop have a different color (e.g. red) than the scale on the right side of the fastening loop and the color marking at the end of the loop (e.g. green);

FIG. 22 a detailed view of the structuring on the upper section of the central fold of the mouth-nose protection of FIG. 20;

FIG. 23 a layer of filter material consisting of two congruent halves with trapezoidal prismatic cushioning elements at the upper edges;

FIG. 24 the layer from FIG. 23 viewed from the lower side in FIG. 23;

FIG. 25 a mouth-nose protection based on two layers of the filter material shown in FIGS. 23 and 24 viewed from above;

FIG. 26 a further mouth-nose protection in which magnets are attached to the rear free ends, which enable the mouth-nose protection to be folded together in a defined manner;

FIG. 27 a side view of the mouth-nose protection of FIG. 26;

FIG. 28 another mouth-nose protection with a gripping element at the central fold;

FIG. 29 a side view of the mouth-nose protection of FIG. 28;

FIG. 30 a detailed view of the area of the mouth-nose protection marked with a circle from FIG. 29.

In principle, the same parts are provided with the same reference signs in the figures.

### DETAILED DESCRIPTON OF THE INVENTION

As used throughout the present disclosure, unless specifically stated otherwise, the term “or” encompasses all possible combinations, except where infeasible. For example, the expression “A or B” shall mean A alone, B alone, or A and B together. If it is stated that a component includes “A, B or C”, then, unless specifically stated otherwise or infeasible, the component may include A, or B, or C, or A and B, or A and C, or B and C, or A and B and C. Expressions such as “at least one of” do not necessarily modify an entirety of the following list and do not necessarily modify each member of the list, such that at least one of “A, B, and C” should not be understood as including only one of A, only one of B, only one of C, or any combination of A, B, and C.

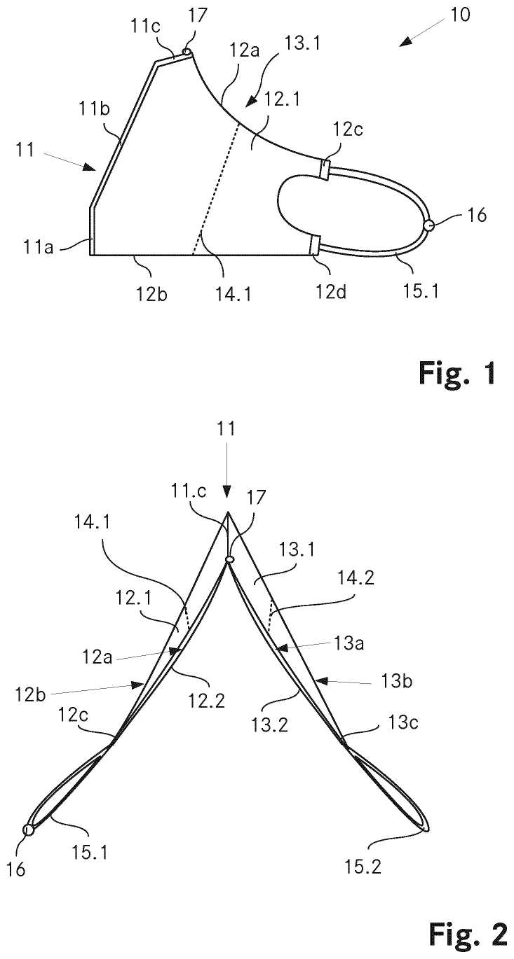

FIG. 1 shows a first mouth-nose protection 10 according to the invention viewed from the left side, while FIG. 2 shows the same mouth-nose protection 10 viewed from the top. The left half of the mouth-nose protection 10 comprises two superimposed layers 12.1, 12.2 of a filter material. The right half of the mouth-nose protection 10 is congruent with the left half and also consists of two superimposed layers 13.1, 13.2 of the same filter material. The layers 12.1, 12.2, 13.1, 13.2 of the filter material define the outer shape of the mouth-nose protection

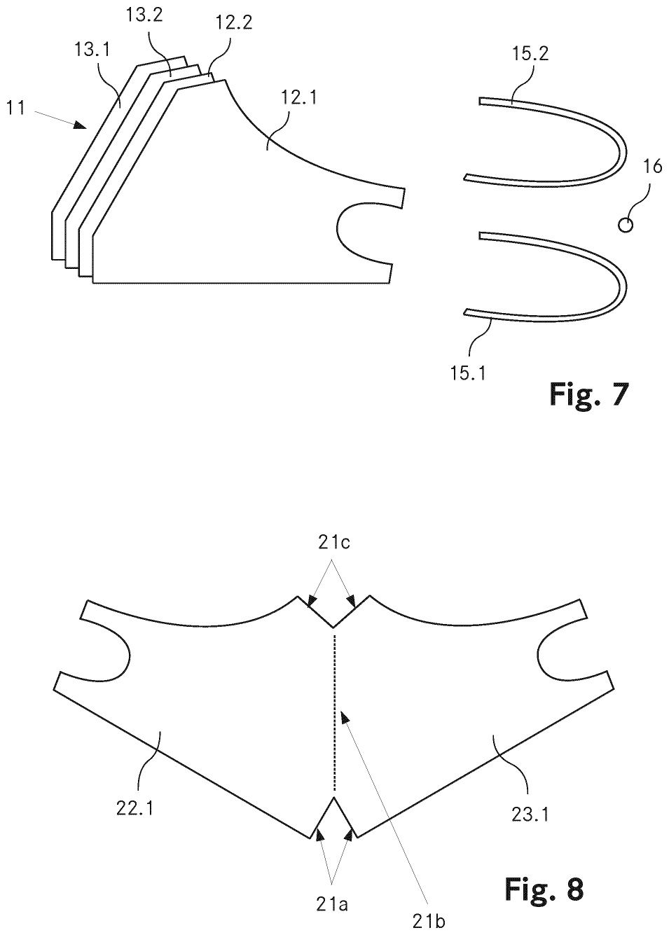

The layers 12.1, 12.2, 13.1, 13.2 of the filter material are all congruent (see also FIG. 7) and are welded together in the area of a central fold 11. The central fold 11 forms a chin-nose line of the mouth-nose protection 10 and has a lower section 11a, a middle section 11b and an upper section 11c, which each run in a straight line and are unwound from one another. A spherical projection is provided at the upper end of the upper section 11c as a tactile marker. The lower and upper sections 11a, 11c are also coated with a phosphorescent paint.

The upper edge 12a of the left half and the upper edge 13a of the right side of the mouth-nose protection 10 run concavely curved to the rear free ends 12c, 13c of the two halves. In contrast, the lower edges 12b, 13b run in a straight line.

At the rear free end 12c of the upper edge 12a and at the rear free end 12d of the lower edge 12b, the two layers 12.1, 12.2 are welded to each other at the edge region of the filter material. Likewise, at the rear free end 13c of the upper edge 13a and at the rear free end 13d of the lower edge 13b, the two layers 13.1, 13.2 are welded to each other at the edge area of the filter material.

Between the central fold 11 and the rear free ends 12c, 12d, 13c, 13d, the two layers 12.1, 12.2 or 13.1, 13.2 are not joined together.

Further welded to the rear free ends 12c, 12d of the left half is a first loop 15.1 of elastic material which serves as a means for securing the mouth-nose protection 10 to the ears or back of the head of a wearer. On the right side, a corresponding second loop 15.2 is attached A spherical magnet 16 is also attached to the first loop 15.1, which serves as a magnetic retaining element with which the mouth-nose protection 10 can be attached to a metallic object when not in use.

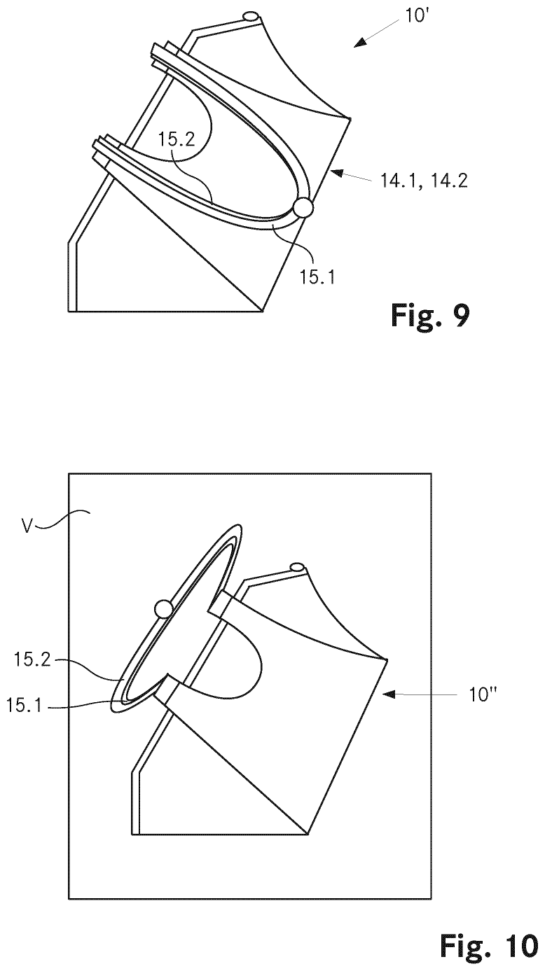

Further, the mouth-nose protection 10 has an additional fold 14.1, 14.2 in each of the left and right halves, the two additional folds 14.1, 14.2 being substantially parallel to the central portion 11b of the central fold 11. The folds 14.1, 14.2 serve as defined folding points for folding the mouth-nose protection 10 (see also FIGS. 9 and 10) and can be introduced, for example, by ironing at elevated temperatures.

The filter material of the mouth-nose protection 10 consists, for example, of a HEPA filter material based on synthetic fibers, as used in vacuum cleaners. The two layers of the filter material together comprise a permeability for particles up to a size of 0.6 μm, measured according to EN 149:2001+A1:2009, of at most 1%.

FIG. 3 shows the mouth-nose protection 10 in the wearing position on the head K of a wearer (the mouth-nose protection is shown transparent for better illustration). As can be seen from FIG. 3, the lower section 11a of the central fold embraces the chin portion of the wearer, while the upper section 11c embraces the nose portion. The central section 11b lies in front of the mouth area of the wearer.

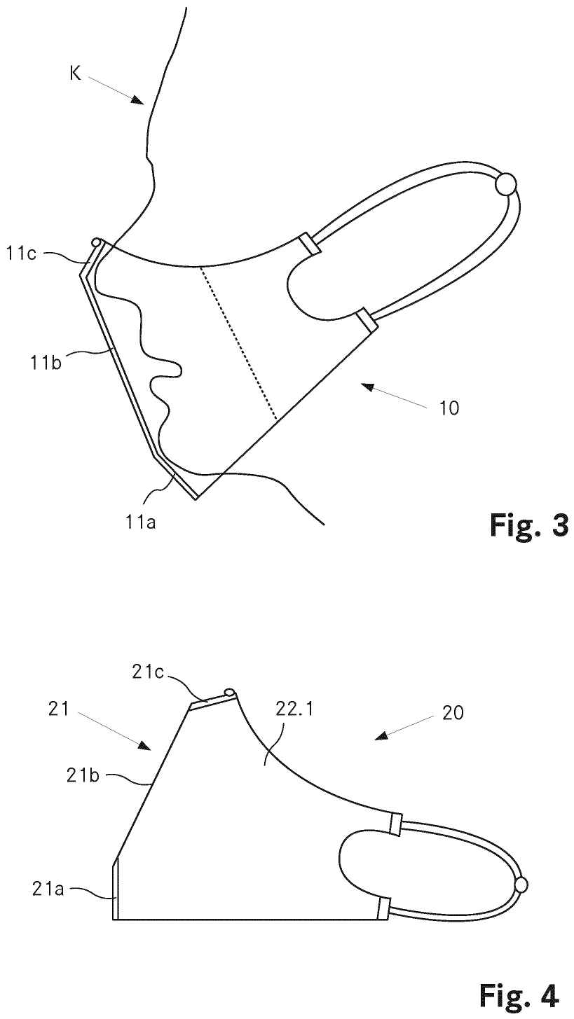

FIG. 4 shows a second mouth-nose protection 20 according to the invention in a top left view. The second mouth-nose protection 20 consists of two one-piece layers of a filter material with a left half 22.1 and a right half 23.1 (not visible in FIG. 4), which are loosely folded around each other in the middle section 21b of the central fold 21 (see also FIG. 8). At the lower and upper sections 21a, 21c, the two layers 22.1, 22.2 are welded together. The remaining structure of the mouth-nose protection 20 is substantially identical in construction to the mouth-nose protection 10 of FIGS. 1-3.

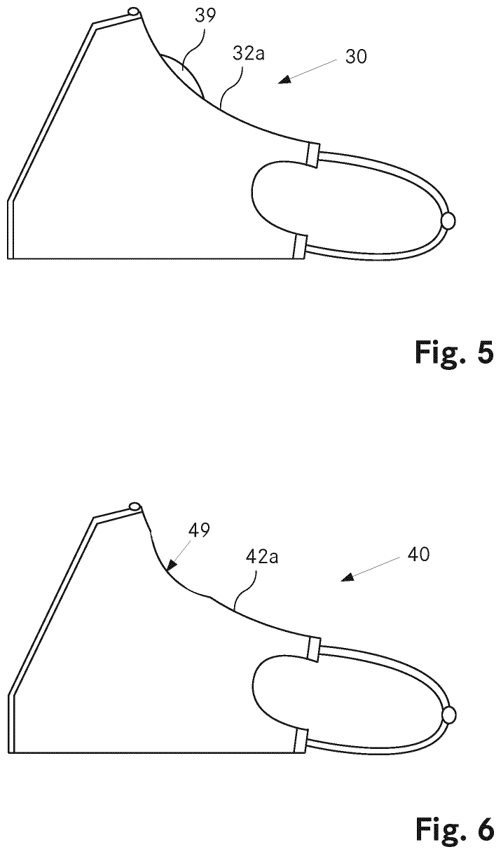

FIG. 5 shows a third mouth-nose protection 30 according to the invention, which is constructed like the mouth-nose protection 10 of FIG. 1, but additionally has a convexly curved projection 39 at the upper and concavely curved edge 32a of the left half in a partial section. A corresponding convexly curved projection is also found on the upper edge of the right half (not visible in FIG. 5). The projection 39 acts as a sealing lip which reduces the unwanted intake and/or outflow of breathable air at the transition of the nose to the cheek regions of the wearer.

FIG. 6 shows a fourth mouth-nose protection 40 according to the invention, which is constructed like the mouth-nose protection 10 of FIG. 1, but additionally has an additional concavely curved recess 49 at the upper and concavely curved edge 42a of the left half in a partial section. A corresponding concavely curved recess is also found at the upper edge of the right half (not visible in FIG. 6). The concave curved recess 49 improved the it of the mouth-nose protection 40 in the nose-cheek area, which also improves the tightness.

FIG. 7 shows on the left side the layers 12.1, 12.2, 13.1, 13.2 of filter material, which are provided for producing the mouth-nose protection 10 of FIGS. 1-3 and are welded at the left edge areas to the central fold 11. On the right in FIG. 7 are shown the loops 15.1, 15.2 as well as the spherical magnet 16, which are welded in at the rear free ends or in FIG. 7 at the right free ends of the layers 12.1, 12.2, 13.1, 13.2.

FIG. 8 shows a layer of filter material consisting of two congruent halves 22.1, 23.1 as used for producing the mouth-nose protection 20 of FIG. 4. Two of the layers shown in FIG. 8 are placed one on top of the other, folded about the central axis of symmetry 21b and welded together with the loops (not shown in FIG. 8) at the adjoining sections 21a, 21c as well as at the free ends.

FIG. 9 shows the mouth-nose protection 10 from FIGS. 1-3 in folded condition. The two halves of the folded mouth-nose protection 10′ lie on top of each other and the areas of the halves lying behind the additional folds 14.1, 14.2 are folded in a superimposed arrangement onto the areas lying in front of the additional folds 14.1, 14.2. The two loops 15.1, are also folded back to obtain the most space-saving arrangement possible. In the arrangement shown in FIG. 9, the mouth-nose protection 10′ can be stored in a space-saving manner, for example, in a trouser pocket, with the inner regions of the mouth-nose protection being well protected from external influences.

FIG. 10 shows the mouth-nose protection 10″ from FIGS. 1-3 in a folded state in a plastic foil V in a vacuum-sealed state. In this case, the loops 15.1, 15.2 are adjacent to the folded layers of the filter material so that no unwanted impressions or pressure points are formed in the filter material. In this state, the mouth-nose protection can be transported, stored, or kept before initial use.

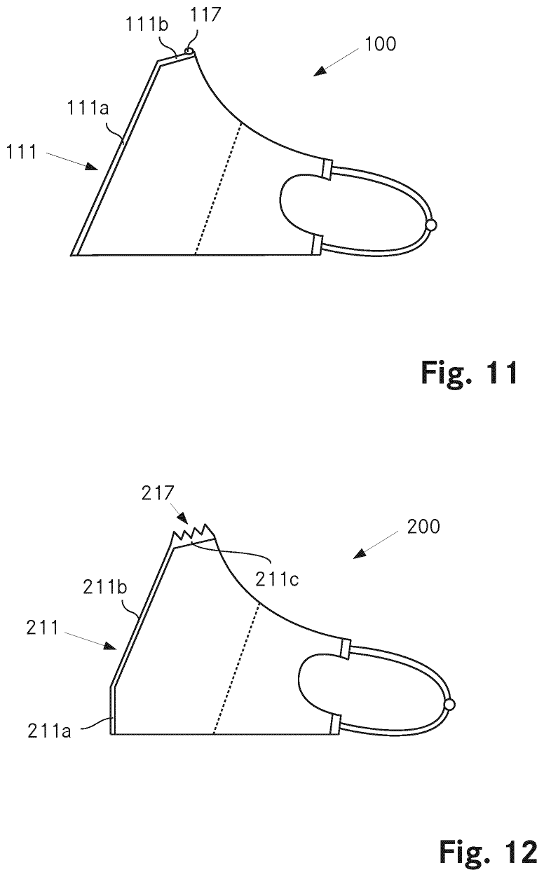

FIG. 11 shows a further mouth-nose protection 100, which is constructed like the mouth-nose protection 10 of FIGS. 1-3, but in contrast thereto has a two-part central fold 111, which comprises a lower section 111a and an upper section 111b, each of which runs in a straight line and is unwound from one another. Thus, the central fold 111 with the upper section 111b can encompass the area of the tip of the nose of the wearer, while the lower section 111a covers the mouth and chin area of the wearer without encompassing the chin.

FIG. 12 shows another mouth-nose protection 200, which is substantially identical in construction to the mouth-nose protection 10 of FIGS. 1-3. Like the mouth-nose protection 100, the mouth-nose protection 200 has a central fold 211 with a lower section 211a, a middle section 211b and an upper section 211c. However, unlike the upper section 11c of the mouth-nose protection 10 of FIG. 1, the upper section 211c of the mouth-nose protection 200 has structuring 217 at the upper free edge in the form of a plurality of sawtooth-shaped projections projecting upwardly toward the front. This allows the nose area of the mouth-nose protection 200 to be easily felt, and if the wearer of the mouth-nose protection is wearing eyeglasses, slippage along the nose edge can be prevented.

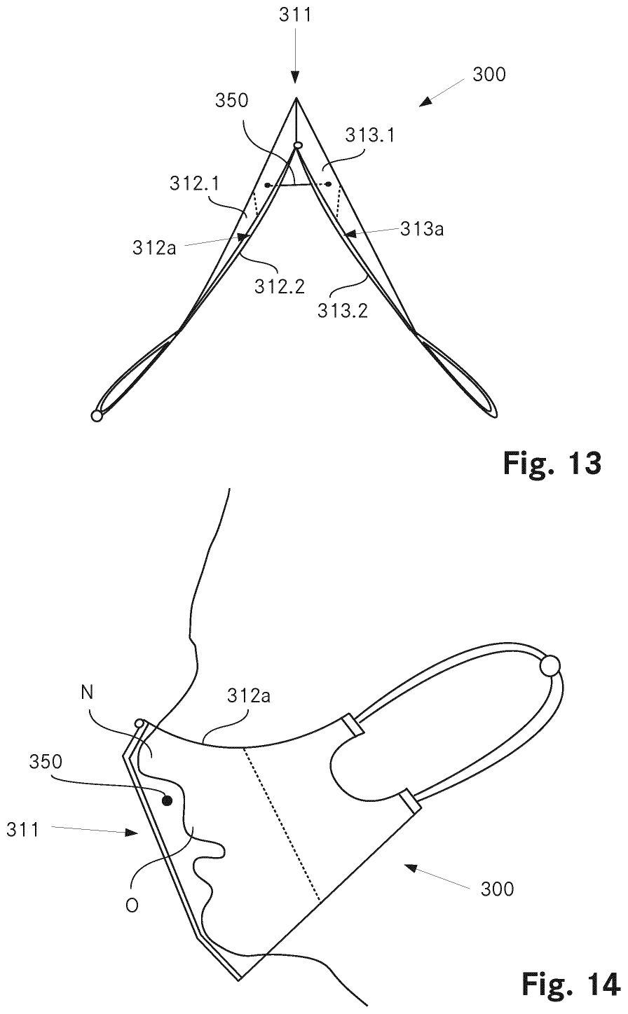

FIG. 13 shows another mouth-nose protection 300, which is constructed substantially like the mouth-nose protection 10 of FIGS. 1-3, but additionally comprises a connecting element 350 in the form of a fabric thread. The connecting element 350 connects the two substantially congruent halves or the two left layers 312.1, 312.2 and the two right layers 313.1, 313.2 of the mouth-nose protection 300. The connecting element 350 extends at a distance from the central fold 311 and the upper edges 312a, 313a substantially horizontally from one half to the other. This is so that the connecting element 350 extends between the upper lip 0 and the lower nose edge N of a wearer when the mouth-nose protection 300 is used as intended, which is shown in FIG. 14.

FIG. 15 shows another mouth-nose protection 400 which is substantially identical in construction to the mouth-nose protection 30 of FIG. 5. However, instead of the convex curved projection 39, the mouth-nose protection 400 has four adjacent rectangular projections 439.1, 439.2, 439.3, 439.4 which are attached to the upper and concave curved edge 412a and are folded to rest side by side on the inside of the left half of the mouth-nose protection 400. Corresponding projections are provided on the right half (not shown in FIG. 15).

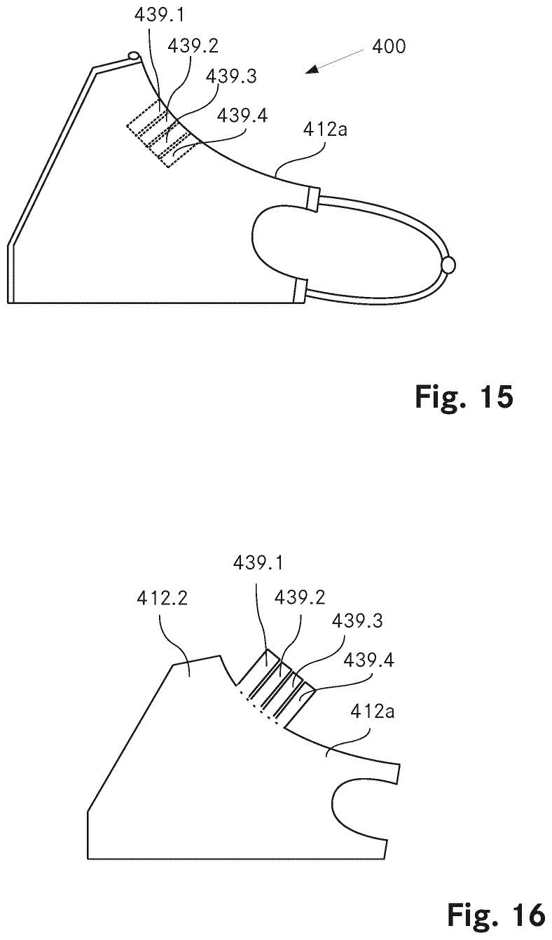

In FIG. 16, the inner layer 412.2 of filter material used for producing the left half of the mouth-nose protection 400 of FIG. 15 is shown. The rectangular projections 439.1, 439.2, 439.3, 439.4 are integral parts of the filter material and are folded around the dashed line so that they come to rest on the inside of the finished mouth-nose protection 400. The outer layer of the left half of the mouth-nose protection 400 may be formed like the outer layer 12.1 of the mouth-nose protection 10, which is shown in FIG. 7. The right half of the mouth-nose protection 400 is designed accordingly.

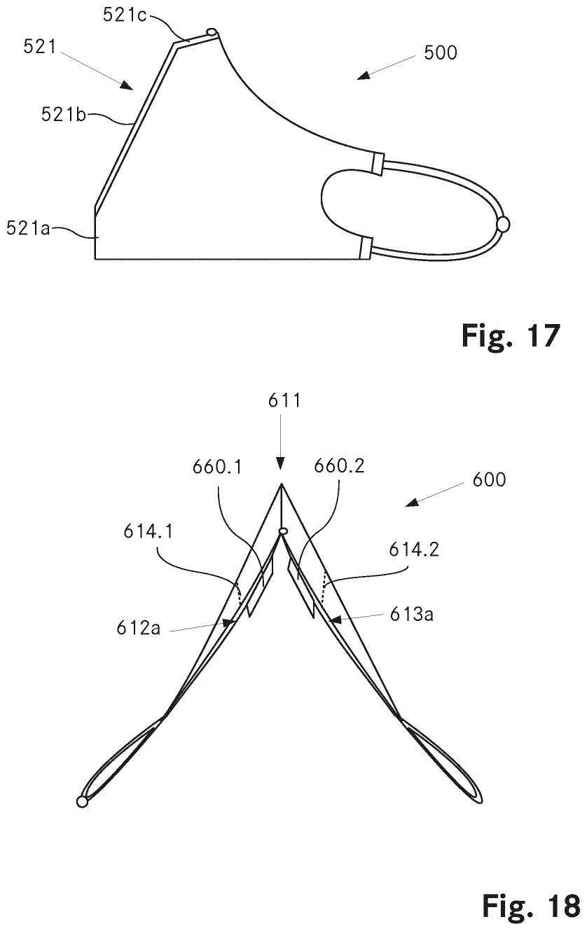

FIG. 17 shows another mouth-nose protection 500, which is a variant of the mouth-nose protection 20 of FIG. 4, in a top view from the left side. The mouth-nose protection 500 consists of two one-piece layers which are folded around each other in the lower section 521a of the central fold 521. At the central and upper sections 521b, 521c, the two layers are welded together. The inner layer of filter material also has a latex coating 550 applied to its inner side in the area of the upper 521c fold as an anti-slip coating. This comes to rest on the lower portion of the bridge of the wearer's nose when the mouth-nose protection 500 is in use. The remainder of the construction of the mouth-nose protection 500 is substantially identical in construction to the mouth-nose protection 20 of FIG. 4.

FIG. 18 shows another mouth-nose protection 600, which is a variant of the mouth-nose protection 10 of FIGS. 1-3, viewed from the top. A cushioning element 660.1, 660.2 is attached to each of the upper edges 612a, 613a of the two halves on the inside of the mouth-nose protection 600. The cushioning elements 660.1, 660.2 are made of foam and comprise the shape of a parallelepiped. They are each attached between the central fold 611 and the additional folds 614.1, 614.2. In other words, the front ends of the cushioning elements 660.1, 660.2 are spaced from the central fold 611 and the rear ends are located in front of the additional folds 614.1, 614.2. The front ends of the cushioning elements 660.1, 660.2 are tapered in a wedge shape and their front end faces are inclined towards the rear. This creates continuous transitions in the nose area and in the cheek area. The remaining structure of the mouth-nose protection 600 is substantially identical in construction to the mouth-nose protection 10 of FIGS. 1-3.

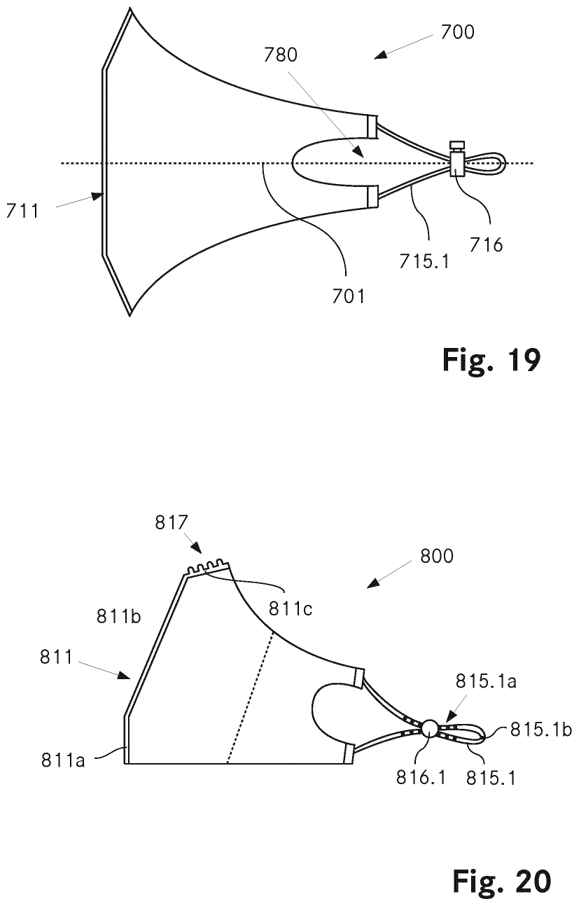

FIG. 19 shows another mouth-nose protection 700 in a top view from the left side. The mouth-nose protection 700 is symmetrical with respect to an axis of symmetry 701, which extends from the central region of the central fold 711 to the central region of the rear end 780 of the mouth-nose protection 700. Accordingly, the central fold 711 is also symmetrical with respect to the axis of symmetry 701. The left half and the right half of the mouth-nose protection 700 shown behind are identical in construction. Like the mouth-nose protection 10 from FIGS. 1-3, the mouth-nose protection 700 also has a total of four layers of filter material (2 per half), which are continuously welded in the region of the central fold 711. Furthermore, the mouth-nose protection 700 has a clamping stopper 716 on the loop 715.1 made of elastic material, with which the size of the loop 715.1 can be changed.

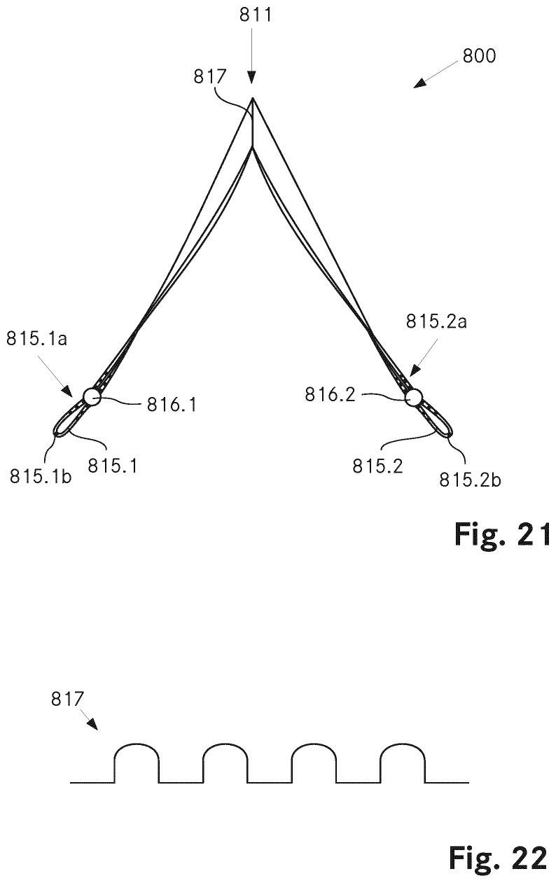

FIG. 20 shows a side view of another mouth-nose protection 800, which is substantially identical in construction to the mouth-nose protection 200 of FIG. 12. Like the mouth-nose protection 200, the mouth-nose protection 800 has a central fold 811 with a lower section 811a, a middle section 811b and an upper section 811c. At the upper section 811c, the mouth-nose protection of FIG. 20 has structuring 817 in the form of a plurality of upwardly projecting rounded rectangular projections. FIG. 21 shows the mouth-nose protection 800 as viewed from the top.

FIG. 22 shows a detailed view of the structuring 817. In contrast to the projections of the embodiment in FIG. 12, the projections in the mouth-nose protection 800 do not taper to a point, but end in a convexly shaped upper edge. This makes the individual projections more pleasant to feel and there is less risk of persons injuring themselves on pointed projections.

Another special feature of the mouth-nose protection 800 are the loops 815.1, 815.2 welded in at the rear free ends and made of elastic material, which serve as a means of fastening the mouth-nose protection 800 to the ears or the back of the head of a wearer.

The left loop 815.1 has a scale 815.1a consisting of regularly spaced red color markings. The scale 815.1a allows the clamp stopper 816.1 to be positioned at a predetermined location. This allows the user to easily set the width of the left loop 815.1 that suits him. At the rearmost end of the left loop 815.1 there is also a further red marking 815.1b, which is clearly visible when viewed from the rear of the mouth-nose protection 800.

Likewise, the right loop 815.2 has a scale 815.2a consisting of regularly applied green color markings. The scale 815.2a allows the second clamp stopper 816.2 to also be positioned at a predetermined point in order to adjust the width of the right loop 815.2. At the rearmost end of the right loop 815.2, another green marking 815.2b is also provided.

Due to the different coloring of the scales 815.1a, 815.2a, the user can detect the left and the right side of the mouth-nose protection 800 in a simple and reliable way. Due to the two differently colored additional markings 815.1b, 815.2b at the rearmost ends of the loop, this is also possible when the user looks at the mouth-nose protection 800 from the rear side.

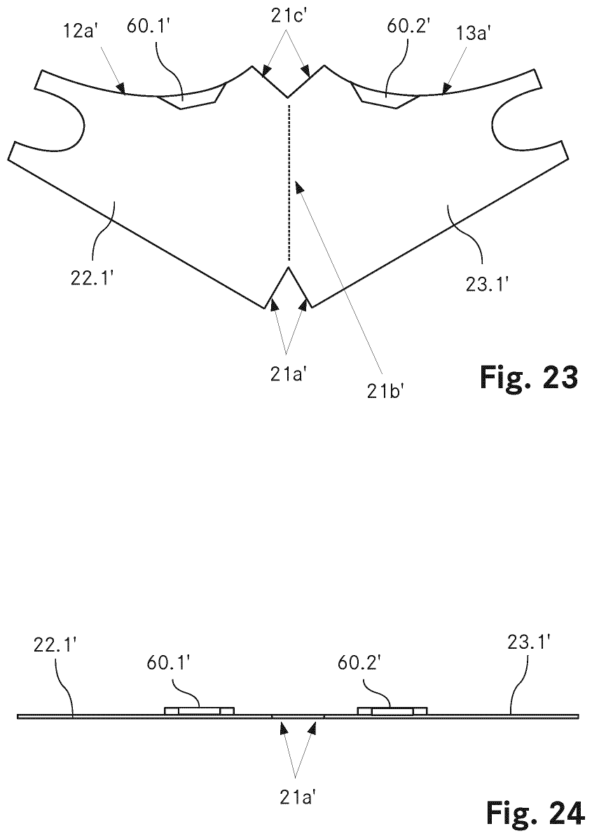

FIG. 23 shows a layer of filter material consisting of two congruent halves 22.1′, 23.1′, as it can be used instead of the layer of FIG. 8, in a view from above.

Compared with the layer in FIG. 8, the layer in FIG. 23 additionally has a substantially trapezoidal prismatic cushioning element 60.1′, 60.2′ on the inside of each of the upper edges 12a′, 13a′ of the two halves 22.1′, 23.1′, which is molded onto the upper edge 12a′, 13a′ in each case. The cushioning elements 60.1′, 60.2′ are adhesively bonded with their trapezoidal bases to the two halves 22.1′, 23.1′ so that the longest side of the trapezoidal base runs along the respective upper edge 12a′, 13a′. FIG. 24 shows the layer from FIG. 23 viewed from the lower side in FIG. 23.

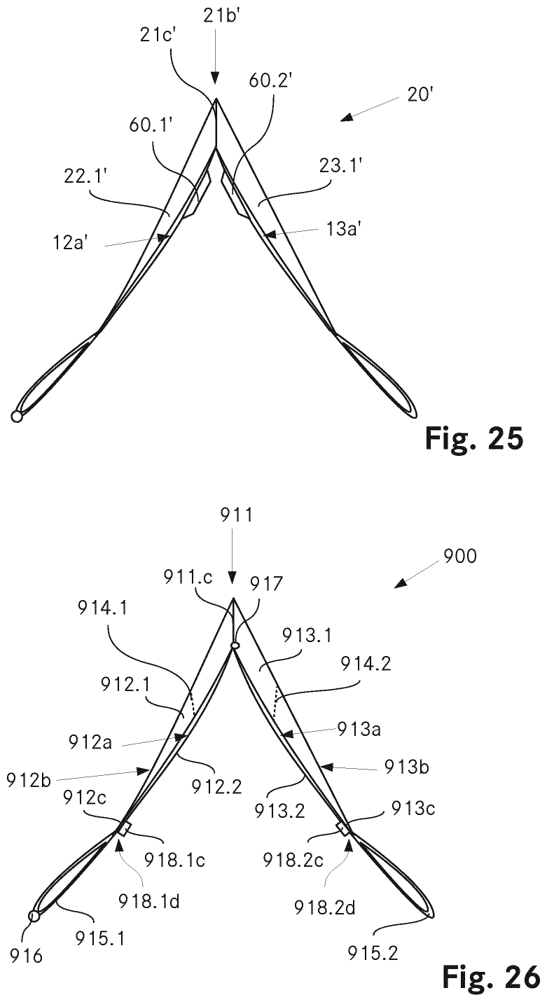

For producing a mouth-nose protection 20′ as shown in FIG. 25, two of the layers shown in FIG. 23 are laid one on top of the other, folded around the central axis of symmetry 21b′ and welded together with loops at the adjoining sections 21a′, 21c′ and at the free ends.

The trapezoidal prismatic cushioning elements 60.1′, 60.2′ thereby provide continuous flexibility transitions in one direction along the upper edges 12a′, 13a′, which in turn contributes to a better seal in the nose and cheek area.

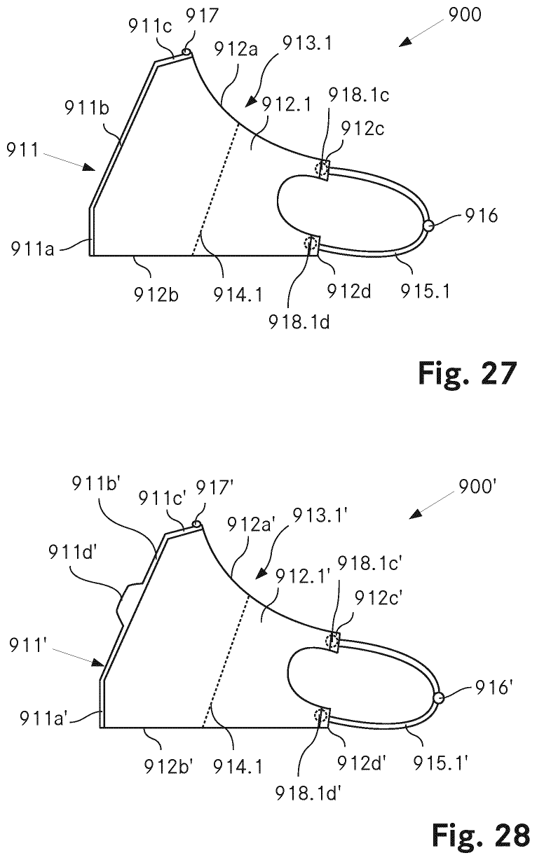

FIG. 26 shows a variant of the mouth-nose protection of FIG. 2 from above. FIG. 27 shows the mouth-nose protection of FIG. 26 viewed from the left side. The elements of the mouth-nose protection 900, which correspond to the elements of the mouth-nose protection of FIG. 2, have the same numbers except for the digit “9” in front.

The mouth-nose protection 900 of FIGS. 26 and 27 has a magnet 918.1c, 918.1d, 918.2c, 918.2d as a fixing element at each of the rear free ends 912c, 912d, 913c, 913d. Opposite magnets 918.1c, 918.2c and 918.1d, 918.2d are selected in such a way that they attract each other magnetically when placed on top of each other. This allows the mouth-nose protection 900 to be folded in a well-defined and predetermined state and stowed, for example, in a trouser or jacket pocket without the mouth-nose protection 900 becoming crumpled.

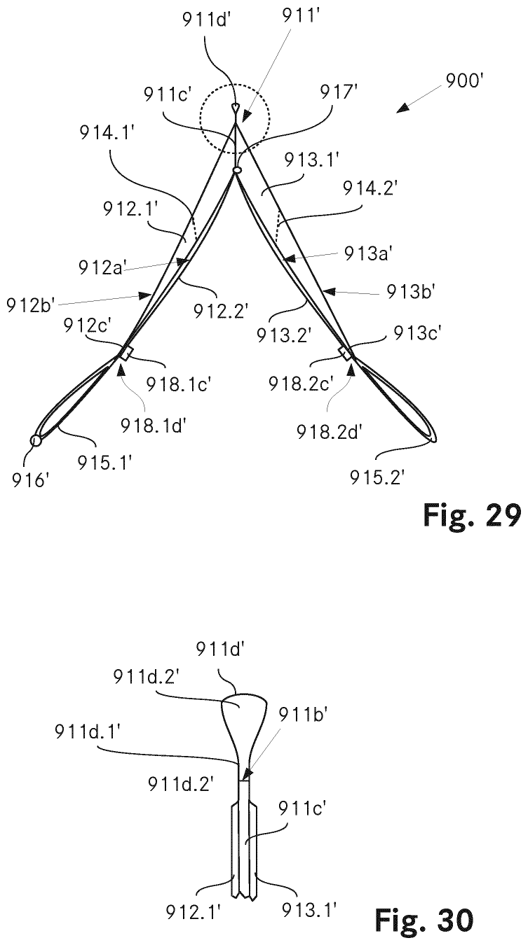

FIG. 28 shows a top view of a variant of the mouth-nose protection of FIGS. 26 and 27. FIG. 29 shows the mouth-nose protection of FIG. 28 viewed from the left side. The elements of the mouth-nose protection 900′, which correspond to the elements of the mouth-nose protection from FIGS. 26 and 27, have the same numbers, but additionally have an apostrophe (').

The mouth-nose protection 900′ of FIGS. 28 and 29 has gripping element 911d′ projecting away to the left in the central section 911b′ of the central fold 911′. In FIG. 28, it can be seen that the free end of the gripping element 911d′ facing away from the central fold 911b′ is designed as a curved edge.

FIG. 30 shows the area marked with a circle in FIG. 29 with the gripping element 911d′ in detail. The gripping element is formed integrally with the filter layers 912.1′, 912.2′, 913.1′, 913.2′. At its free end 911d.2′ facing away from the central fold 911b′, the gripping element 911d′ is thicker than in the region 911.1′ facing the central fold 911b′. In the area 911.1′, the filter layers are welded together, while there is no materially bonded connection at the free end 911d.2′.

Measured in the direction of the middle section 911b′, the gripping element 911d′ has a length of, for example, about 15 mm at the longest point or in the region of the transition to the fold 911b′ and a thickness of, for example, about 0.8 mm in the region of the free end 911d.2′.

The embodiments shown above are to be understood merely as illustrative examples which can be modified as desired within the scope of the invention.

For example, it is possible to provide differently designed central folds 11, 21, which comprise, for example, curved sections.

Likewise, the mouth-nose protections 10, 20, 30, 40 can be produced with differently configured edges, for example differently curved edges. For example, the lower edges of the mouth-nose protection 10, 20, 30, 40 can be curved concavely upward.

Likewise, more than two layers can be combined, for example, to increase filtering performance. It is also possible to provide additional layers without filtering effect, for example decorative layers on the outside of the mouth-nose protection or layers for cushioning on the inside of the mouth-nose protection to improve comfort.

Furthermore, on all mouth-nose protectors, clamp stoppers 716 or similar devices can be attached to the elastic loops. Likewise, gripping elements such as those shown in FIGS. 28-30 can be attached to all mouth-nose protection.

In summary, advantageous mouth-nose protection has been provided, which is characterized in particular by high effectiveness, good wearing comfort and ease of manufacture.

1. A mouth-nose protection for reducing the transmission of pathogens by secretion droplets, the mouth nose protection comprising:
a central folds defining a chin-nose line of the mouth-nose protection and configured to divide the mouth-nose protection into two substantially congruent halves; hand
fastening means configured to fasten the mouth-nose protection to ears of a wearer or to a back of a head of the wearer, the fastening means further configured to attach to the ends of the two substantially congruent halves facing away from the central fold; and
at least two superimposed layers of a filter material defining an outer shape of the mouth-nose protection and arranged only partially connected at their edges.

2. The mouth-nose protection according to claim 1, wherein the partial connection is a materially bonded connection and the at least two superimposed layers of the filter material are arranged substantially congruent.

3. (canceled)

4. The mouth-nose protection according to claim 1, wherein the at least two layers are connected to each other on less than 50%, of the total length of their edges and the upper edges of the two halves, which extend from the uppermost region of the central fold to the free ends of the two halves, the at least two layers of the filter material are not connected to one another.

5. (canceled)

6. (canceled)

7. (canceled)

8. (canceled)

9. (canceled)

10. The mouth-nose protection according to claim 1, wherein the at least two layers of the filter material are connected to each other exclusively in the region of the central fold and in the regions of the free ends of the two halves.

11. The mouth-nose protection according to claim 1, wherein the central fold comprises a lower portion, a middle portion and an upper portion, the lower portion and the upper portion running at an angle of 10°-80° to the middle portion.

12. (canceled)

13. (canceled)

14. (canceled)

15. (canceled)

16. (canceled)

17. The mouth-nose protection according to claim 1, further comprising a structuring arranged in an uppermost section of the central fold at the free edge, the structuring comprising one or more projections projecting at least one of forwards and upwards and a plurality of spaced rectangular projections.

18. (canceled)

19. (canceled)

20. (canceled)

21. (canceled)

22. (canceled)

23. The mouth-nose protection according to claim 1, further comprising a cushioning element attached to each of the upper edges of the two halves on the inside of the mouth-nose protection, wherein the cushioning elements are trapezoidal prisms.

24. (canceled)

25. The mouth-nose protection according to claim 1, further comprising one or more color markings arranged on the fastening means.

26. The mouth-nose protection according to claim 25, further comprising at least one stopper configured to be displaced and positioned along the color marking(s).

27. The mouth-nose protection according to claim 1, wherein the fastening means further comprises an elastic material loop attached to each of the two ends facing away from the central fold.

28. The mouth-nose protection according to claim 27, further comprising one or more markings arranged on each of the two loops and comprising different colors.

29. The mouth-nose protection according to claim 1, further comprising at least one fixing element configured such that the two congruent halves can be held together at the ends facing away from the central fold when not in use, wherein the at least one fixing element comprises at least two magnets, one magnet on each of the ends of the two congruent halves of the mouth-nose protection facing away from the central fold being attached to the mouth-nose protection.

30. (canceled)

31. (canceled)

32. The mouth-nose protection according to claim 1, wherein:
the central fold comprises a projecting gripping element for gripping the mouth-nose protection with two fingers; and
the gripping element is arranged to protrude in a direction away from the face of the wearer when the mount-nose protection is worn by the wearer.

33. (canceled)

34. The mouth-nose protection according to claim 32, wherein a free end of the gripping element facing away from the central fold is configured to be at least one of thicker, at least in sections, than a region facing the central fold and a curved edge.

35. (canceled)

36. (canceled)

37. (canceled)

38. The mouth-nose protection according to claim 32, wherein the gripping element:
comprises filter material,
is formed integrally with the at least two superimposed layers of the filter material; and
wherein a region of the gripping element facing the central fold comprises a materially bonded connection of filter material; and
wherein in the free end of tie gripping element facing away from the central fold, the filter material is not materially bonded.

39. (canceled)

40. (canceled)

41. The mouth-nose protection according to claim 1, wherein the mouth-nose protection is sealed in a plastic foil.

42. (canceled)

43. A method of producing a mouth-nose protection, the method comprising the steps of:
providing a one-piece first layer of a filter material having an axisymmetric shape and a substantially congruent one-piece second layer of a filter material;
arranging the one-piece first layer and one-piece second layer one above the other;
folding of the one-piece first layer and one-piece second layer along an axis of symmetry so as to create a central fold;
partial joining the one-piece first layer and one-piece second layer at their edges; and
attaching one means of securing the mouth-nose protection to the ears or to the back of the head of a wearer at each end of the two halves facing away from the central fold.

44. (canceled)

45. The method of producing a mouth-nose protection according to claim 43, the method, comprising the steps of:
a) providing a first half of a first layer of a filter material and a second half of the first layer;
b) providing a first half of a second layer of a filter material and a second half of the second layer, wherein the first half of the second layer and the second half of the second layer are substantially congruent with the first half of the first layer and the second half of the first layer;
c) superimposing the first half of the first layer and the first half of the second layer and the second half of the first layer and the second half of the second layer;
d) partially joining layers in an edge region of an intended chin-nose line of the mouth-nose protection with formation of a central fold;
e) attaching a means each for fastening the mouth-nose protection to the ears or to the back of the head of a wearer at the ends of the two halves facing away from the central fold.

46. (canceled)
